(19) United States
(12) Patent Application Publication
(10) Pub. No.: US 2004/0075069 A1
(43) Pub. Date: Apr. 22, 2004

(54) Intercept value for fluids

(76) Inventors: Andrea Bartoli, Reggio Emilia (IT); Vittorio Grizzi, Reggio Emilia (IT)

Correspondence Address: WILLIAM COLLARD, COLLARD & ROE, P.C., 1077 NORTHERN BOULEVARD, ROSLYN, NY, 11576, US

(21) Appl. No.: 10/471,310

(22) PCT Filed: Mar. 8, 2002
(86) PCT No.: PCT/IT02/00147

(30) Foreign Application Priority Data
Mar. 13, 2001 (IT) M02001A000045

(51) Int. Cl. F16K 7/04

(52) U.S. Cl. 251/5

(57) ABSTRACT

An intercept valve for fluids, comprising a tubular element (2) made of a deformable material, which internally defines a passage provided with an inlet (3) and an outlet (4) for a fluid to be intercepted. The tubular element (2) is housed internally of a second tubular element (5) made of steel and having an inlet (7) through which, on command, a pressurised fluid is introduced which closes the passage by laterally choking the tubular element (2). In an open configuration, a median section of the tubular element (2), which is choked to close the tubular element (2), is slightly pre-choked in a preferred choking direction and is free to expand in a direction which is transversal to the preferred choking direction. The valve guarantees a sealed closure. The valve can be used in particular in a device for filling containers with a liquid product.

### TECHNICAL FIELD

The invention relates to an intercept valve for fluids. Specifically, though not exclusively, the invention can be usefully employed in a device for filling containers with a liquid or highly-viscous fluid.

### BACKGROUND ART

The prior art teaches an intercept valve for a liquid comprising a small tube made of elastically deformable material, for example rubber, which is closed by lateral pinching to interrupt a flow of liquid. In known valves of this type the deformable tube internally defines a cylindrical passage and is contained within a chamber, also cylindrical, which has a slightly bigger diameter than the external dimensions of the tube. One of the drawbacks of ksnown valves of this type is that the pinching of of the rubber tube, which closes the valve, can be irregular. Typically, the tube in the choked configuration can form lobes which do not close the tube (and therefore the valve) perfectly. Another drawback consists in the relatively brief working life of the valve, which is subjected to a series of pinches and expansions that cause it to wear rapidly. The main aim of the present invention is to provide a valve which can obviate the above-cited drawbacks in the prior art. An advantage of the invention is that it guarantees a perfect seal on the valve closure. A further advantage is that it provides a constructionally simple and economical valve. A still further advantage is that it provides a long-lasting valve. These aims and advantages and more besides are all attained by the present invention, as it is characterised in the appended claims.

### DISCLOSURE OF INVENTION

Further characteristics and advantages of the present invention will better emerge from the detailed description that follows of a preferred but non-exclusive embodiment of the invention, illustrated purely by way of a non-limiting example in the accompanying figures of the drawings, in which:

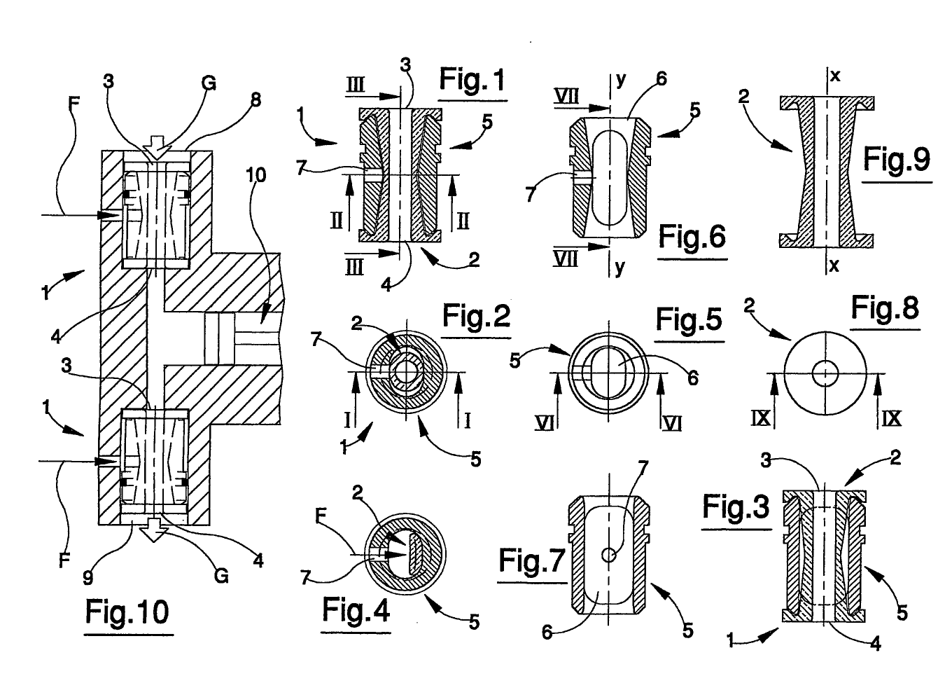

FIG. 1 is a section made according to line I-I of FIG. 2 of a valve made according to the invention;

FIG. 2 is section II-II of FIG. 1;

FIG. 3 is section III-III of FIG. 1;

FIG. 4 is the section of FIG. 2 with the valve in a closed configuration;

FIG. 5 is a view from above of the rigid external second tubular element defining the chamber containing the deformable first tubular element;

FIG. 6 is section VI-VI of FIG. 5;

FIG. 7 is section VII-VII of FIG. 6;

FIG. 8 is a view from above of the deformable first tubular element;

FIG. 9 is section IX-IX of FIG. 8;

FIG. 10 is a filling device of a liquid in which the valve of the invention is used. With reference to the above-cited figures, 1 denotes in its entirety an intercept valve for fluids, in particular for liquids, comprising a tubular element 2 made of a deformable material (for example silicone rubber).

The tubular element 2 internally defines a cylindrical conduit provided at opposite ends thereof with an inlet 3 and an outlet 4 for the fluid to be intercepted. The tubular element 2 is axialsymmetric and exhibits two flanged opposite ends.

The tubular element 2 is contained in an external second element 5, made of a rigid material (for example steel) which internally defines a housing chamber 6 for the internal tubular element 2. The chamber 6 has a lateral inlet 7 though which a pressurised control fluid (compressed air) can be introduced to laterally choke the tubular element 2 up until the conduit is obstructed. FIG. 4 shows the deformable tubular element in the choked configuration corresponding to the closure of the passage of the intercepted fluid.

The chamber 6 housing the tubular element 2 has a median section, considered according to a section plane normal to the longitudinal axis x-x of the tubular element, which is narrow and oval in shape. The inlet 7 of the pressurised control fluid is located at the narrow and oval section. The inlet 7 of the pressurised fluid is located on one of the two longer sides of the above-mentioned oval section. The shape of the housing chamber 6 of the tubular element 2 is complex, comprising an egg-timer-shaped surface, i.e. made up of two opposite truncoconical surfaces which meet at a median section of inferior diameter. The egg-timer surface is coaxially intersected by a specially-shaped cylindrical surface, with a straight section, but oval rather than circular, i.e. a cylindrical surface generated by a straight generatrix (parallel to the axis y-y of the egg-timer surface) which follows a flattened curve of oval shape. The flattened curve, which corresponds with the perimeter of the narrowed section of the housing chamber 6 (see FIG. 5) has a shorter side which is about the same size as the diameter of the median section of the egg-timer surface (and slightly smaller than the diameter which the tubular element 2, in undeformed state, exhibits in the same zone, so as to determine a slight pre-choking of the element 2). The oval-section cylindrical surface is tangential to the narrowed section of the housing chamber 6 at the short side of the flattened curve, while “cutting” a part of the egg-timer surface (as can be more clearly seen in FIGS. 6 and 7, where thin lines show the “cut” zones) at the other zones of the curve.

The internal tubular element 2 comprises an internal surface delimiting the passage of the flow to be regulated, which internal surface is cylindrical with a straight circular section, and an external surface in the shape of an egg-timer, of a same or slightly bigger size than the above-mentioned egg-timer surface defining the housing chamber 6. Preferably the internal wall of the housing chamber 6 exerts a slight pre-choking pressure on the tubular element 2 at the parts where the egg-timer surface of the housing chamber 6 is not “cut” by the oval-shaped cylindrical surface.

The straight median section of the tubular element 2 is a preferential choking section, having a relatively narrowed breadth with respect to the other sections: the pinching in the breadth is such that the choking which accounts for the closing of the conduit is concentrated in the narrowed median section of the tubular element 2.

The tubular element 2 has, in the area of the weakened section subject to greatest pinching, two diametrically-opposite zones which, when the valve is open, when the pressurised fluid is not operative in closing the conduit, are very close or, preferably, interact contactingly with the internal wall of the housing chamber so as to be slightly pre-choked (this can be seen in FIGS. 1 and 2), while the other zones in the area of the weakened section are further away from the internal wall, and do not interact contactingly with it and are therefore not pre-choked, but are free to expand (this can be seen in FIG. 3).

At the weakened section, the tubular element 2 is therefore slightly pre-choked (even in the absence of the action of the pressurised control fluid) in one direction (i.e. in the smaller-diameter direction of the oval section of the housing chamber 6), and free to be choked in a perpendicular direction to the above direction (i.e. in the direction of larger diameter).

The inlet 7 of the control fluid is at the position of one of the zones of the tubular element 2 which are slightly pre-choked.

In substance, the tubular element 2, in the absence of any action on the part of the pressurised control fluid, interacts contacting with all of the internal wall of the housing chamber with the exception of two diametrically-opposite areas which involve a part of the weakened zone.

In other words, a section of the tubular element 2, preferably the weakened and more deformable section, is contained in the housing chamber 6 in such a way as to be slightly pre-choked in one direction and free to expand in the perpendicular direction. This is allowed by the shape of the section of the housing chamber 6, which is different from the shape of the weakened section of the tubular element 2; in the specific case, the section of the chamber is oval, while the section of the tubular element 2 is circular; one section is preferably symmetrical according to two perpendicular axes. By virtue of this configuration, when the control fluid is injected into the housing chamber 6, the tubular element 2 will choke as illustrated in FIG. 4, i.e. always in the direction of the pre-choked part.

When the action of the control fluid ceases, the tubular element 2 returns elastically into its open configuration.

Thanks to the fact that th ehousing chamber 6 slightly interferes with a part of the tubular element 2, it has been seen during operation that apart from guaranteeing closure, there is also less wear on the tubular element 2, giving a longer working life.

FIG. 10 shows an application of the above-described valve. This illustrates a filling device for a liquid comprising a conduit provided with an inlet 8 and an outlet 9 for the liquid, an alternative pump 10 which operates in the conduit, and two intercept valves 1, identical to the above-described valve, of which one functions as a suction valve and the other as a delivery valve. Each valve 1 is commanded to open and close by a pneumatic transmission system, of known type and not illustrated, which operates in phase with the alternative pump 10. Each valve 1 is housed in an appropriate seating and is provided with at least one seal which sealingly isolates the control fluid (indicated by arrows F) from the flow of the product to be intercepted (indicated with arrows G).

1). An intercept valve for fluids, comprising a tubular element (2) made of a deformable material, which internally defines a passage provided with an inlet (3) and an outlet (4) for a fluid to be intercepted, which tubular element (2) is housed internally of a housing chamber (6) having an inlet (7) through which, on command, a pressurised fluid is introduced which closes the passage by laterally choking the tubular element (2).

2). The valve of claim 1, wherein, in an open configuration, at least one section of the tubular element (2) is slightly pre-choked in a preferred choking direction and is free to expand in a direction which is transversal to the preferred choking direction.

3). The valve of claim 1 or 2, wherein at least one section of the housing chamber (6), in a plane which is normal to an axis (x-x) of the tubular element (2), is oval, the at least one section being located at the oval pre-choked section of the tubular element (2).

4). The valve of claim 3, wherein the inlet (7) of the pressurised fluid is located at a same position as the pre-choked section of the tubular element (2).

5). The valve of claim 4, wherein the inlet (7) of the pressurised fluid is located at a longer side of the oval section of the housing chamber.

6). The valve of any one of the claims from 3 to 5, wherein the tubular element (2) exhibits, at the oval section of the housing chamber (6), a weakened section at which the choking is effected to block passage of the liquid.

7). The valve of any one of the preceding claims, wherein the housing chamber (6) of the tubular element (2) exhibits a narrowing of section at which narrowing the tubular element (2) is slightly pre-choked in a first direction and is free to stretch in a direction which is transversal to the section which is subject to narrowing.

8). The valve of any one of the preceding claims, wherein the tubular element (2), in at least one section according to a plane which is perpendicular to the axis (x-x) of the tubular element and in an absence of pressure of the pressurised fluid, has two diametrically-opposite zones which are very close or which interact contactingly with a wall internally delimiting the housing chamber (6), while other zones of the tubular element (2) in the at least one section are further away from the internal wall of the housing chamber.

9). The valve of claim 8, wherein the inlet (7) of the pressurised fluid is located at one of zones of the tubular element (2) which are very close to or interact with the internal wall of the housing chamber (6).

10). The valve of any one of the preceding claims, wherein, in an open configuration of the valve, the housing chamber (6) of the tubular element (2) is delimited by an internal wall which embraces at least apart of the tubular element (2) with slight interference there-with, except for two diametrically-opposite zones at which the internal wall is distant from the tubular element (2) in order to enable the tubular element (2) to be lengthened in a preferred direction.
